(19) United States
(12) Patent Application Publication
(10) Pub. No.: US 2017/0004212 A1
(43) Pub. Date: Jan. 5, 2017

(54) METHOD AND APPARATUS FOR ACQUIRING SEARCH RESULTS

(71) Applicant: Xiaomi Inc., Beijing (CN)

(72) Inventors: Zhijun CHEN, Beijing (CN); Tao ZHANG, Beijing (CN); Fei LONG, Beijing (CN)

(73) Assignee: Xiaomi Inc.

(21) Appl. No.: 15/083,244

(22) Filed: Mar. 28, 2016

(30) Foreign Application Priority Data
Jun. 30, 2015 (CN) 201510373332.9

(51) Int. Cl. G06F 17/30

(52) U.S. Cl. CPC G06F 17/30867; G06F 17/30525; G06F 17/30551

(57) ABSTRACT

A method for acquiring search results is disclosed. The method includes: acquiring face information of a user by face recognition, when detecting that a search event is started in a terminal; sending a search request to a search server according to the face information and a search query of the search event; and receiving user-related search results determined by the search server through a search based on the face information and the search query.

### CROSS-REFERENCE TO RELATED APPLICATIONS

This application is based upon and claims the priority of Chinese Patent Application No. 201510373332.9, filed on Jun. 30, 2015, the disclosure of which is incorporated herein by reference in its entirety.

### TECHNICAL FIELD

The present disclosure generally relates to the field of Internet technology and, more particularly, relates to a method and an apparatus for acquiring search results.

### BACKGROUND

With developments of the Internet technology, searching has become one of the most frequently used functions when users visit the Internet.

In the related art, search engine websites can provide personalized searching functions, i.e., selecting search results in tune with a user's preferences according to the user's browsing and searching habits. This function requires the user to log into the search engine website with the user's account. Generally, a user logs in his/her account by: starting an application program of the search engine website or opening a webpage of the search engine website, selecting login function, and inputting a username and a password registered in advance. The login process is complete when the search engine website verifies the user account username and password. After the user logs in the search engine website, the personalized search function may be available to the user.

### SUMMARY

According to a first aspect of the present disclosure, there is provided a method for acquiring search results. The method includes: acquiring face information of a user by face recognition, when detecting that a search event is started in a terminal; sending a search request to a search server according to the face information and a search query of the search event; and receiving user-related search results determined by the search server through a search based on the face information and the search query.

According to another aspect of the present disclosure, there is provided a method for acquiring search results. The method includes: receiving a search request sent by a terminal, the search request including at least face information of a user and a search query; verifying whether the face information belongs to a registered user; if the face information belongs to a registered user, performing a search based on the search query according to a personalized search pattern of the registered user, and determining search results related to the registered user; and sending the search results related to the registered user to the terminal.

According to another aspect of the present disclosure, there is provided a terminal for acquiring search results. The terminal includes a processor and a storage device for storing instructions executable by the processor. The processor is configured to: acquire face information of a user by face recognition, when detecting that a search event is started in the terminal; send a search request to a search server according to the face information and a search query of the search event; and receive user-related search results determined by the search server through a search based on the face information and the search query.

According to another aspect of the present disclosure, there is provided a server for acquiring search results. The server includes a processor and a storage device for storing instructions executable by the processor. The processor is configured to: receive a search request sent by a terminal, the search request including at least face information of a user and a search query; verify whether the face information belongs to a registered user; if the face information belongs to a registered user, perform a search based on the search query according to a personalized search pattern of the registered user, and determine search results related to the registered user; and send the search results related to the registered user to the terminal.

### BRIEF DESCRIPTION OF THE DRAWINGS

Accompanying drawings herein are incorporated in and constitute a part of the description, for illustrating the embodiments according to the present disclosure and explaining the principles of the present disclosure together with the description.

FIG. 1 is a flowchart showing a method for acquiring search results, consistent with embodiments of the present disclosure.

FIG. 2 is a flowchart showing another method for acquiring search results, consistent with embodiments of the present disclosure.

FIG. 3A is a flowchart showing another method for acquiring search results, consistent with embodiments of the present disclosure.

FIG. 3B is a flowchart showing detailed steps in step 301 shown in FIG. 3A.

FIG. 3C is a flowchart showing detailed steps in step 302 shown in FIG. 3A.

FIG. 3D is a flowchart showing detailed steps in step 304 shown in FIG. 3A.

FIG. 4 is a flowchart showing another method for acquiring search results, consistent with embodiments of the present disclosure.

FIG. 5 is a flowchart showing a method for logging into a search server, consistent with embodiments of the present disclosure.

FIG. 6 is a block diagram showing an apparatus for acquiring search results, consistent with embodiments of the present disclosure.

FIG. 7 is a block diagram of the first acquisition module shown in FIG. 6.

FIG. 8 is a block diagram of the first sending module shown in FIG. 6.

FIG. 9 is a block diagram showing another apparatus for acquiring search results consistent with embodiments of the present disclosure.

FIG. 10 is a block diagram of the first verification module shown in FIG. 9.

FIG. 11 is a block diagram showing an apparatus for acquiring search results, consistent with embodiments of the present disclosure.

FIG. 12 is a block diagram showing an apparatus for acquiring search results according to an embodiment, consistent with embodiments of the present disclosure.

FIG. 13 is a block diagram showing a system for acquiring search results, consistent with embodiments of the present disclosure.

### DETAILED EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

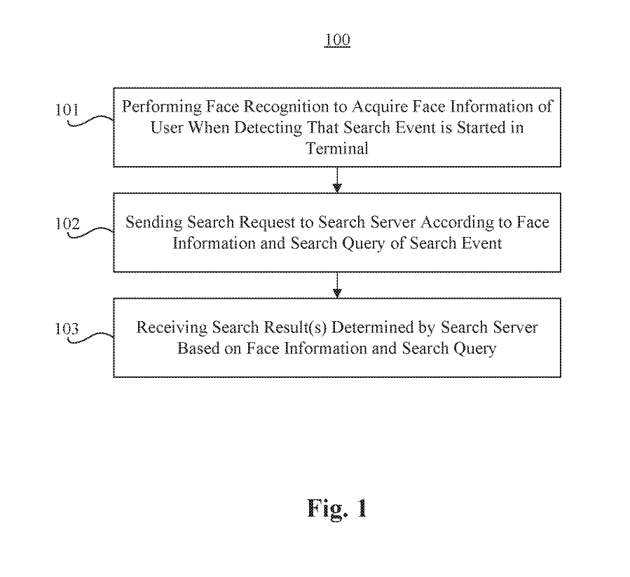

FIG. 1 is a flow chart showing a method 100 for acquiring search results, consistent with embodiments of the present disclosure. The method 100 may be performed by, for example, a terminal. As shown in FIG. 1, the method 100 includes the following steps.

In step 101, the terminal performs face recognition to acquire face information of a user when detecting that a search event is started in a terminal.

In step 102, the terminal sends a search request to a search server according to the face information and a search query of the search event.

In step 103, the terminal receives search results related to the user from the search server, which is determined based on the face information and the search query.

In the illustrated embodiment, when detecting that a search event is started, the terminal sends the face information and the search query to the search server for login and search. The terminal then receives the user-related search results determined by the search server according to the face information and the search query. Therefore, the method 100 improves the efficiency of the login process during the search, the accuracy of the search results, and the human-machine interaction.

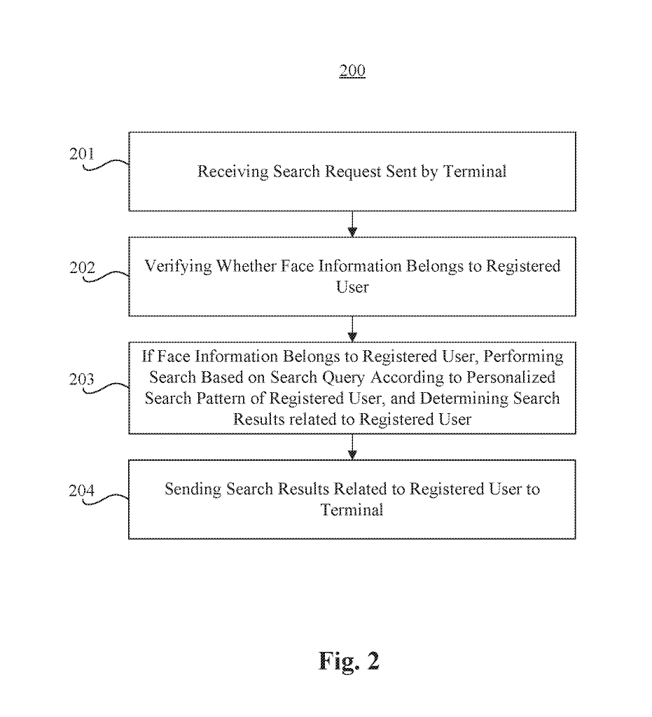

FIG. 2 is a flow chart showing a method 200 for acquiring search results, consistent with embodiments of the present disclosure. The method 200 may be performed by, for example, a server. As shown in FIG. 2, the method 200 includes the following steps.

In step 201, the server receives a search request sent by a terminal. The search request includes at least face information and a search query.

In step 202, the server verifies whether the face information belongs to a registered user.

In step 203, if the face information belongs to a registered user, the server performs a search based on the search query according to a personalized search pattern of the registered user, and determines the search results related to the registered user.

In step 204, the server sends the search results related to the registered user to the terminal.

In the illustrated embodiment, the server receives the face information sent by the terminal and the search query, verifies whether the user is a registered user according to the face information, and determines the search results related to the registered user when the user is determined to be a registered user. Therefore, the method 200 improves the efficiency of the login process during the search, the accuracy of the search results, and the human-machine interaction.

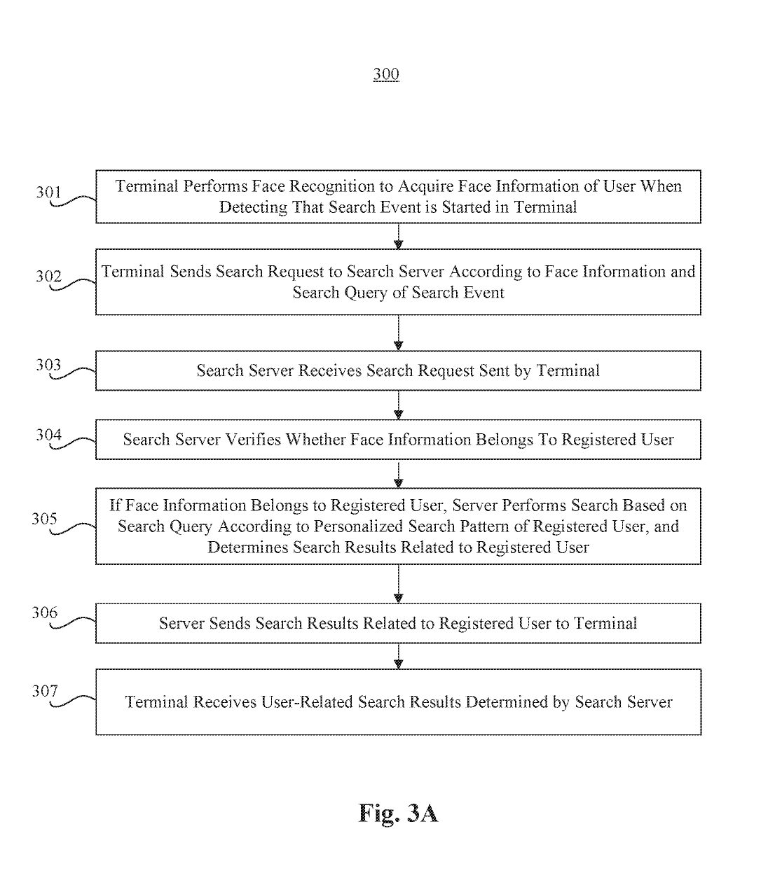

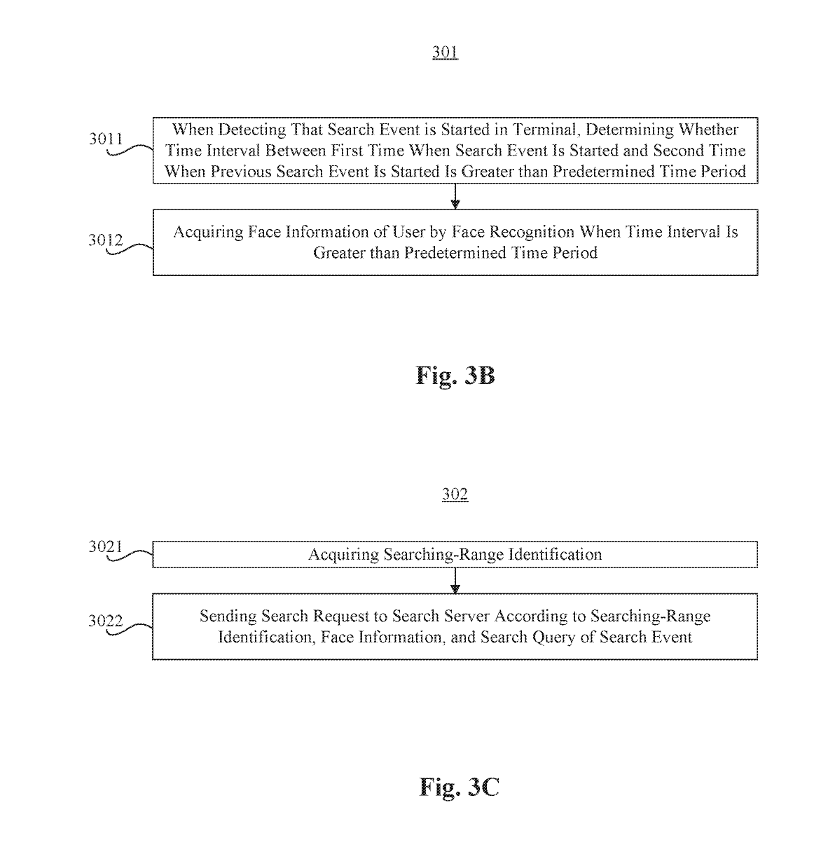

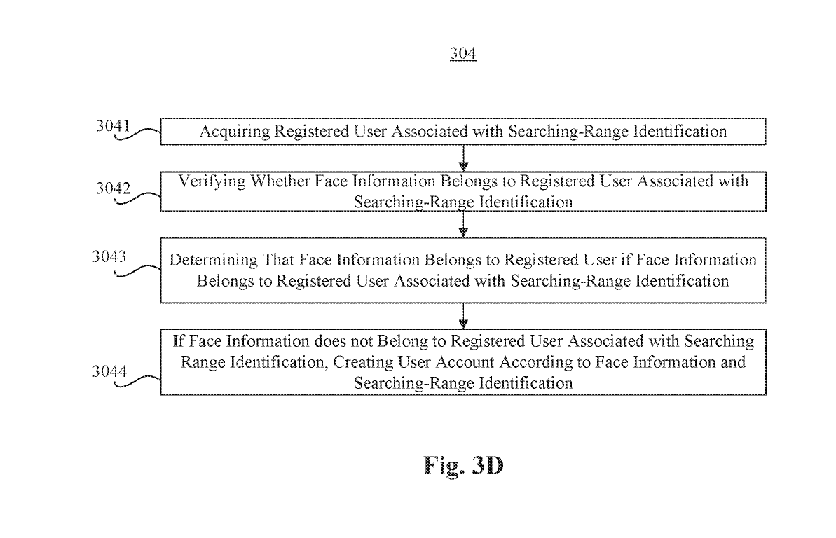

FIG. 3A is a flow chart showing a method 300 for acquiring search results, consistent with embodiments of the present disclosure. The method 300 may be performed by a system including a terminal and a server. As shown in FIG. 3A, the method 300 includes the following steps.

In step 301, the terminal performs face recognition to acquire face information of the user when detecting that a search event is started in the terminal.

In one embodiment, when a user starts a browser and selects a search engine website, the user can then start a search event in the search engine website. In one embodiment, when the user starts an application program of the search engine website, the user can operate the terminal to start a search event.

After the user submits the search query to the search engine webpage or to the application program of the search engine website, and selects a search confirmation button, the search event is started. The search event includes the search query that is input by the user in an input box, and the search query may include text, audio and video files, and pictures, etc.

In one embodiment, after detecting that a search event is started, the face information is acquired by starting a camera of the terminal to obtain a face image of the user present in front of the terminal and by performing face recognition based on the image.

Since the user usually operates the terminal by holding it in hand, in normal situations, the user would face the screen of the terminal, so that the front camera of the terminal will be started to perform face recognition to acquire the face information.

In some embodiments, a user may search using the search engine webpage or the application program of the search engine website multiple times. The user's identity may have been verified after the face information is sent in a first search request. Within a predetermined period of time after the user is verified, second and subsequent search requests from the terminal to the server may include no face information while the server still provides personalized search result services. In one embodiment, whether to include face information in a search request depends on a time difference between a first time when face information is transmitted to the server and a second time when generating a subsequent search request. If the time difference is less than the predetermined time period, the terminal includes no face information in the subsequent search request. In one embodiment, whether to include face information in a search request depends on a time difference between a third time when a present search event is started and a time when the previous search event is started. If the time difference is less than a predetermined time period, the terminal includes no face information in the subsequent search request.

In some embodiments, referring to FIG. 3B, step 301 may include steps 3011 and 3012.

In step 3011, the terminal determines whether a time interval between a first time when the present search event is started and a second time when the previous search event is started is greater than a predetermined time period, when detecting that the present search event is started in the terminal.

In step 3012, face recognition is performed to acquire face information of the user if the time interval is greater than the predetermined time period.

In step 302, the terminal sends a search request to the search server according to the face information and the search query in the search event.

The search request may include the face information and the search query. In some embodiments, a data size of the face information may be too large for the search server to process, and matching the face information with data in the server's face-information database may not be sufficiently accurate. Accordingly, the user verification based on the face information may be performed with other search information, such as a search-range identification.

In one embodiment, a predetermined searching-range identification may be included in the search request, such that the search server may determine a searching range of the face information.

The searching-range identification includes one or more of a device identification, a cloud service account, an application account, a location identification, or a network identification.

In some embodiments, the search server may store relationship information of user accounts associated with various types of searching-range identifications. Relationship information may be set by users according to their needs when they register the accounts with the search server, or by the search server according to the searching-range identifications the users submit at the time when the users register with the search server.

In one embodiment, the search identification may include a device identification, so that the server can match the face information in a search request with face information of one or more users corresponding to the device having the device identification, thereby determining whether the user has been registered.

In one embodiment, the search identification may include cloud service account information, so that the server can match the face information in the search request with face information of one or more users corresponding to the cloud service account, thereby determining whether the user has been registered. In some embodiments, a cloud service account may be shared by one or more devices corresponding to one or more users.

In one embodiment, the search identification may include an application account, so that the search server can match the face information in the search request with the face information of one or more users corresponding to the application account, thereby determining whether the user has been registered.

In one embodiment, the search identification may include a location identification, so that the search server can match the face information in the search request with the face information of one or more users corresponding to a predetermined location or area, thereby determining whether the user has been registered.

In one embodiment, the search identification may include a network identification, so that the search server can match the face information in the search request with one or more users accessing a network having the network identification via a network device, such as a router, in a predetermined location or area, thereby determining whether the user has been registered.

In some embodiments, the server may verify the user's identify with one or more searching-range identifications to determine a searching range of the face information.

In some embodiments, referring to FIG. 3C, the step 302 may include steps 3021 and 3022:

In step 3021, the terminal acquires a searching-range identification. The searching-range identification includes one or more of a device identification, a cloud service account, an application account, a location identification, or a network identification.

In step 3022, the terminal sends a search request to the search server according to the searching-range identification, the face information, and the search query in the search event.

Referring again to FIG. 3A, in step 303, the search server receives the search request sent by the terminal. The search request includes at least the face information and the search query.

In some embodiments, the search request also includes a searching-range identification. The searching-range identification includes one or more of a device identification, a cloud service account, an application account, a location identification, or a network identification.

In step 304, whether the face information belongs to a registered user is verified.

In some embodiments, referring to FIG. 3D, when the search request includes a searching-range identification, step 304 may include the following steps.

In step 3041, a registered user associated with the searching-range identification is acquired.

The search server may store relevant information of registered users, including face information, personalized search pattern, and search history records of the user, and so on.

When a search request includes a searching-range identification, it may greatly narrow the targets for matching with the face information. For example, when the searching-range identification is a device identification, the server can look for registered users associated with the device identification based on the device identification and compare the face information included in the search request with face information of the registered users associated with the device identification. Because the number of registered users using a device having the device identification would not be too large, the server performs less comparisons or calculations to verify whether the face information of the search request corresponds to a registered user.

In step 3042, whether the face information belongs to the registered user associated with the searching-range identification is verified.

In step 3043, it is determined that the face information belongs to a registered user if the face information belongs to the registered user associated with the searching-range identification.

In step 3044, if the face information does not belong to the registered user associated with the searching-range identification, a user account is created according to the face information and the searching-range identification.

After the user account is created, a message of creating the user account may be sent to the terminal, to inform the user that the user account has been successfully created, and to show to the user the searching-range identifications of the created account.

Referring again to FIG. 3A, in step 305, if the face information belongs to a registered user, the search server performs a search based on the search query according to a personalized search pattern of the registered user, and determines the search results related to the registered user.

In one embodiment, based on the personalized search pattern of the registered user, the search results of the search query can be ranked. The server selects a predetermined number of top-ranked search results according to the personalized search pattern of the registered user.

In step 306, the search results related to the registered user are sent to the terminal.

In step 307, the terminal receives the user-related search results determined by the search server through the search on the basis of the face information and the search query.

In the illustrated embodiment, when a search event is started in the terminal, the terminal sends the face information and the search query to the search server for login and search. The search server receives the face information and the search query sent by the terminal and verifies whether the user is registered on the basis of the face information, and determines the search results related to the registered user if the user is a registered user. The terminal receives the user-related search results determined by the search server according to the face information and the search query.

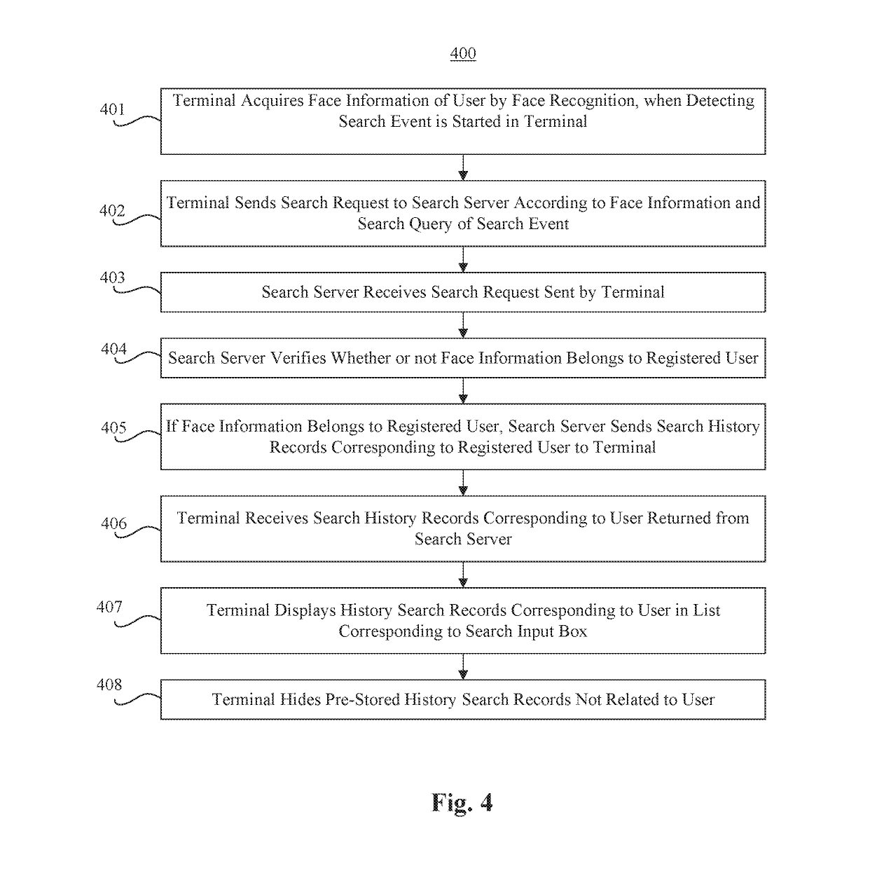

FIG. 4 is a flow chart showing a method 400 for acquiring search results, consistent with embodiments of the present disclosure. The method 400 may be performed by a system including a terminal and a search server. As shown in FIG. 4, the method 400 includes the following steps.

In step 401, the terminal performs face recognition to acquire face information of the user when detecting that a search event is started in the terminal.

In step 402, the terminal sends a search request to the search server according to the face information and a search query of the search event.

In step 403, the search server receives the search request sent by the terminal. The search request includes at least the face information and the search query.

In step 404, whether the face information belongs to a registered user is verified.

In step 405, if the face information belongs to a registered user, search history records corresponding to the registered user are sent to the terminal.

The search server may store relevant information of the registered user, including the face information, a personalized search pattern, and the search history records of the user.

After each registered user logs in with his/her user account, the search server may store the search query sent by each registered user, and generate the search history records for each registered user.

In step 406, the terminal receives the search history records corresponding to the user returned by the search server.

In step 407, the search history records corresponding to the user are displayed in a list corresponding to a search input box.

For example, a pull-down list, provided adjacent to the search input box of the search engine webpage or in the application program of the search engine website, is automatically displayed for showing the search history records returned from the search server.

In step 408, a hiding operation is performed to hide pre-stored search history records not related to the user.

The pre-stored search history records not related to the user may be the search query, input or submitted by the other users and stored in the terminal or in the application program of the search engine website.

By hiding the search history records irrelevant to the user, it is possible to avoid revealing the privacy of the other users.

In the illustrated embodiment, after the terminal logs in to a search server using face information of a user, the search history records pertaining to the user are returned to the terminal to be displayed, while the search history records not pertaining to the user will be hidden. The search efficiency of the system is improved, and the search records of other users are prevented from being revealed.

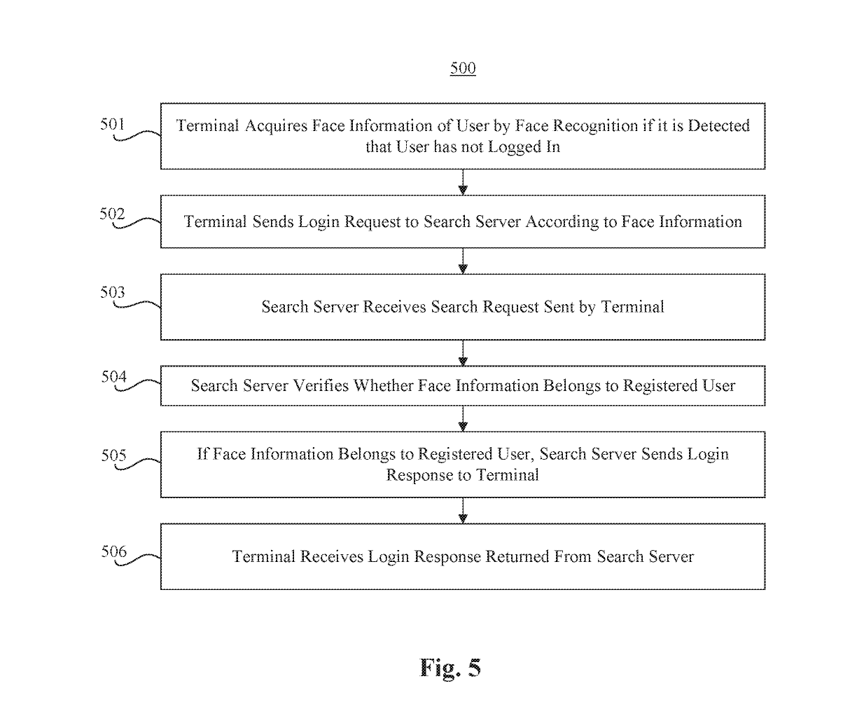

FIG. 5 is a flow chart showing a method 500 for logging into a search server, consistent with embodiments of the present disclosure. The method 500 may be performed by a system including a terminal and a search server, and a portion of a method for acquiring search results. As shown in FIG. 5, the method 500 includes the following steps.

In step 501, the terminal performs face recognition to acquire face information of a user if it is detected that the user has not logged in.

In the illustrated embodiment, if it is detected that the user has not logged in when the user is using a search engine webpage or an application program of the search engine website, the user may be prompted to perform a login operation using the face information.

For example, a pop-up dialog box is displayed, which includes information indicating whether the user needs to perform a login operation or not. If the user selects to perform the login operation, the terminal performs face recognition to acquire face information of the user as explained above.

In step 502, a login request is sent to the search server according to the face information.

In one embodiment, the login request may include a searching-range identification for the search server to verify the user identity. The terminal may execute the above-explained step 3021 (FIG. 3C) of acquiring searching-range identification so that the search server may perform the corresponding matching process.

In step 503, the search server receives the login request sent by the terminal. The login request includes the face information.

In step 504, whether the face information belongs to a registered user is verified.

In step 505, if the face information belongs to the registered user, a login response indicating the login is successful is sent to the terminal.

In step 506, the terminal receives the login response returned from the search server after the search server has performed verification according to the face information.

In some embodiments, after logging in the search server, subsequent search requests sent by the terminal do not need to include the face information, while the search server may continue to provide the personalized searching service based on the login status of the terminal.

In the illustrated embodiment, by acquiring face information and performing automatic login when it is detected that the user has not logged in, complex manual login can be avoided to improve human-machine interaction.

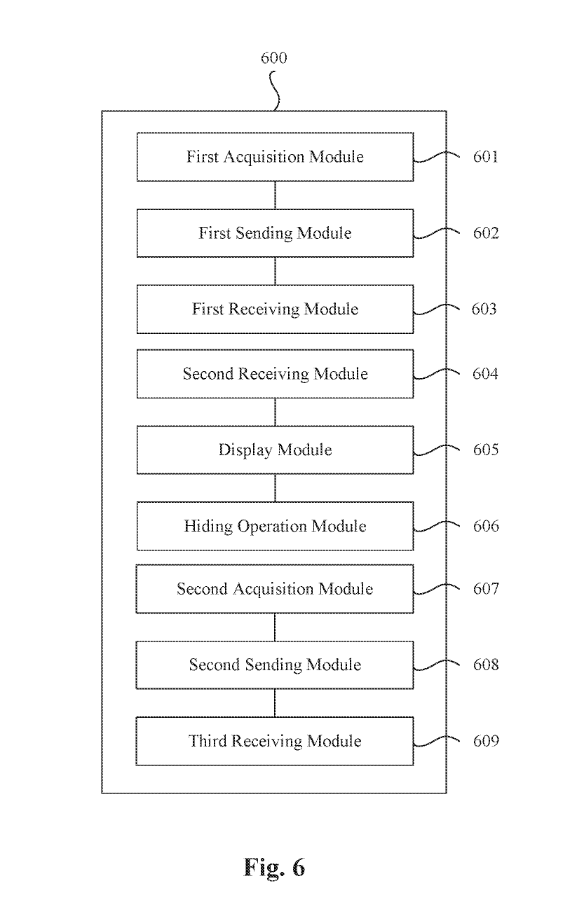

Consistent with and corresponding to the methods for acquiring search results explained above, the present disclosure further provides apparatuses for acquiring search results. For example, the apparatuses may be a terminal. FIG. 6 is a block diagram showing an apparatus 600 for acquiring search results. As shown in FIG. 6, the apparatus 600 comprises a first acquisition module 601, a first sending module 602, and a first receiving module 603.

The first acquisition module 601 is configured for performing face recognition and acquiring face information of a user when detecting that a search event is started in the apparatus 600.

The first sending module 602 is configured for sending a search request to a search server according to the face information and a search query of the search event.

The first receiving module 603 is configured for receiving the user-related search results determined by the search server through a search on the basis of the face information and the search query.

As shown in FIG. 7, the first acquisition module 601 (FIG. 6) may include a judgment sub-module 6011 and a first acquisition sub-module 6012.

The judgment sub-module 6011 is configured for determining whether a time interval between a time when the present search event is started and a time when the previous search event is started is greater than a predetermined time period.

The first acquisition sub-module 6012 is configured for acquiring face information of a user by the face recognition if the time interval is greater than the predetermined time period.

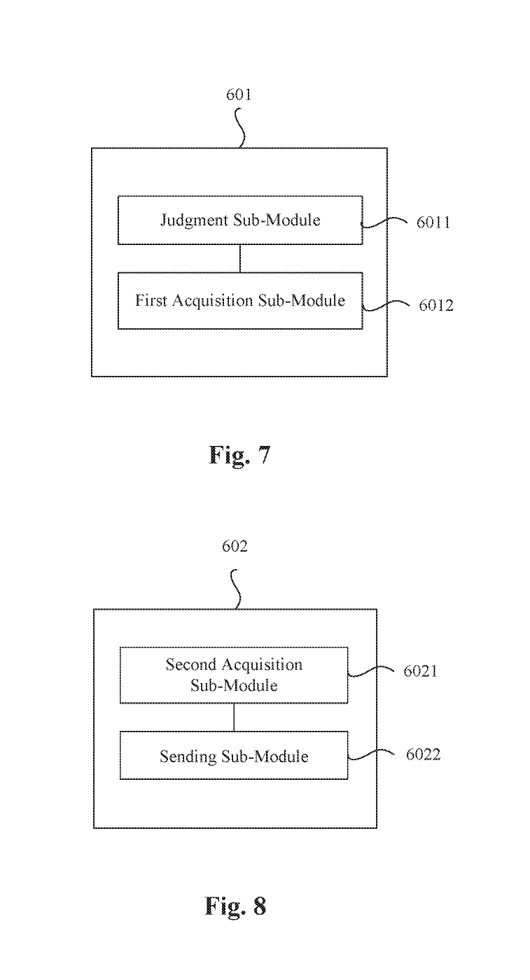

A shown in FIG. 8, the first sending module 602 (FIG. 6) may include a second acquisition sub-module 6021 and a sending sub-module 6022.

The second acquisition sub-module 6021 is configured for acquiring a searching-range identification. The searching identification includes one or more of a device identification, a cloud service account, an application account, a location identification, or a network identification.

The sending sub-module 6022 is configured for sending a search request to the search server according to the searching identification, the face information, and the search query in the search event.

In some embodiments, the apparatus 600 further comprises: a second receiving module 604 and a display module 605.

The second receiving module 604 is configured for receiving search history records corresponding to the user returned by the search server.

The display module 605 is configured for displaying the search history records corresponding to the user in a list corresponding to a search input box.

In some embodiments, the apparatus 600 further comprises a hiding operation module 606 configured for hiding pre-stored search history records not related to the user.

In some embodiments, the apparatus 600 further comprises: a second acquisition module 607, a second sending module 608, and a third receiving module 609.

The second acquisition module 607 is configured for acquiring face information of a user by face recognition, when it is detected that the user has not logged in the search server.

The second sending module 608 is configured for sending a login request to the search server according to the face information.

The third receiving module 609 is configured for receiving the login response returned from the search server after the search server performs verification according to the face information.

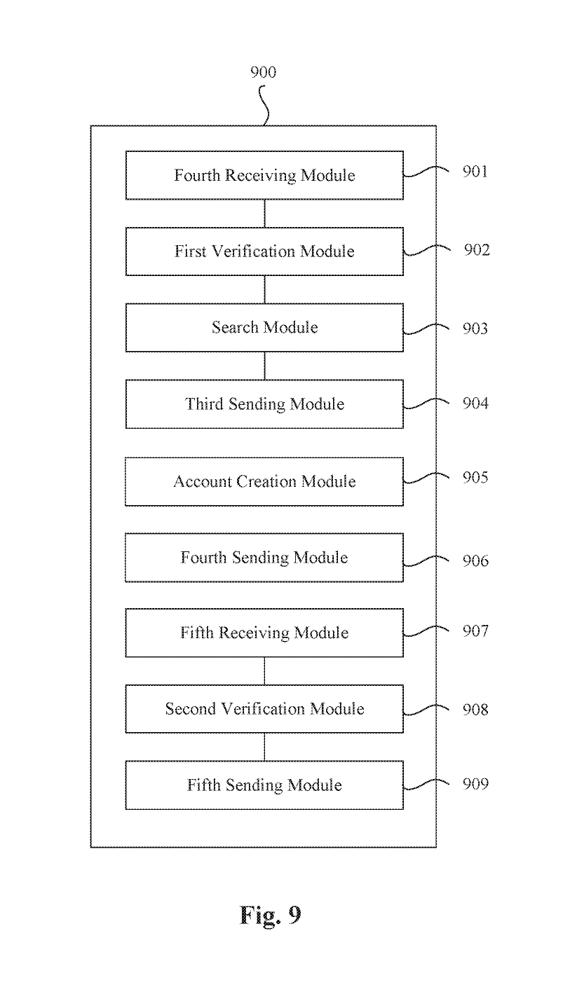

Consistent with and corresponding to the methods for acquiring search results explained above, the present disclosure provides an apparatus 900 for acquiring search results. The apparatus 900 may be a server explained above. As shown in FIG. 9, the apparatus 900 comprises: a fourth receiving module 901, a first verification module 902, a search module 903, and a third sending module 904.

The fourth receiving module 901 is configured for receiving a search request sent by a terminal. The search request includes at least face information of a user and a search query.

The first verification module 902 is configured for verifying whether the face information belongs to a registered user.

The search module 903 is configured for performing a search, when the face information belongs to a registered user, based on the search query according to a personalized search pattern of the registered user, and determining search results related to the registered user.

The third sending module 904 is configured for sending the search results related to the registered user to the terminal.

In some embodiments, the search request further includes a searching-range identification. The searching-range identification includes one or more of a device identification, a cloud service account, an application account, a location identification, or a network identification.

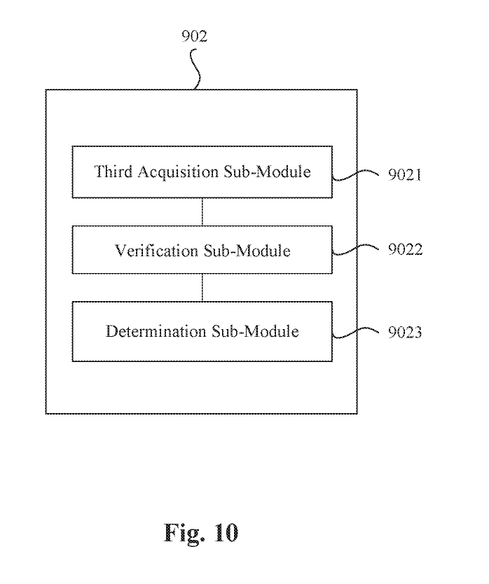

In some embodiments, as shown in FIG. 10, the first verification module 902 includes: a third acquisition sub-module 9021, a verification sub-module 9022, and determination sub-module 9023.

The third acquisition sub-module 9021 is configured for acquiring one or more registered users associated with the searching-range identification;

The verification sub-module 9022 is configured for verifying whether the face information belongs to the registered users associated with the searching-range identification.

The determination sub-module 9023 is configured for determining that the face information belongs to a registered user, when the face information belongs to the registered users associated with the searching-range identification.

In some embodiments, the apparatus 900 further comprises an account creation module 905 configured for creating a user account according to the face information and the searching-range identification, when the face information does not belong to the registered users associated with the searching-range identification.

In some embodiments, the apparatus 900 further comprises a fourth sending module 906 configured for sending, when the face information belongs to a registered user, the search history records corresponding to the registered user to the terminal.

In some embodiments, the apparatus 900 further comprises: a fifth receiving module 907, a second verification module 908, and a fifth sending module 909.

The fifth receiving module 907 is configured for receiving a login request sent by a terminal. The login request includes face information of a user.

The second verification module 908 is configured for verifying whether the face information belongs to a registered user.

The fifth sending module 909 is configured for sending a login response to the terminal, when the face information belongs to a registered user.

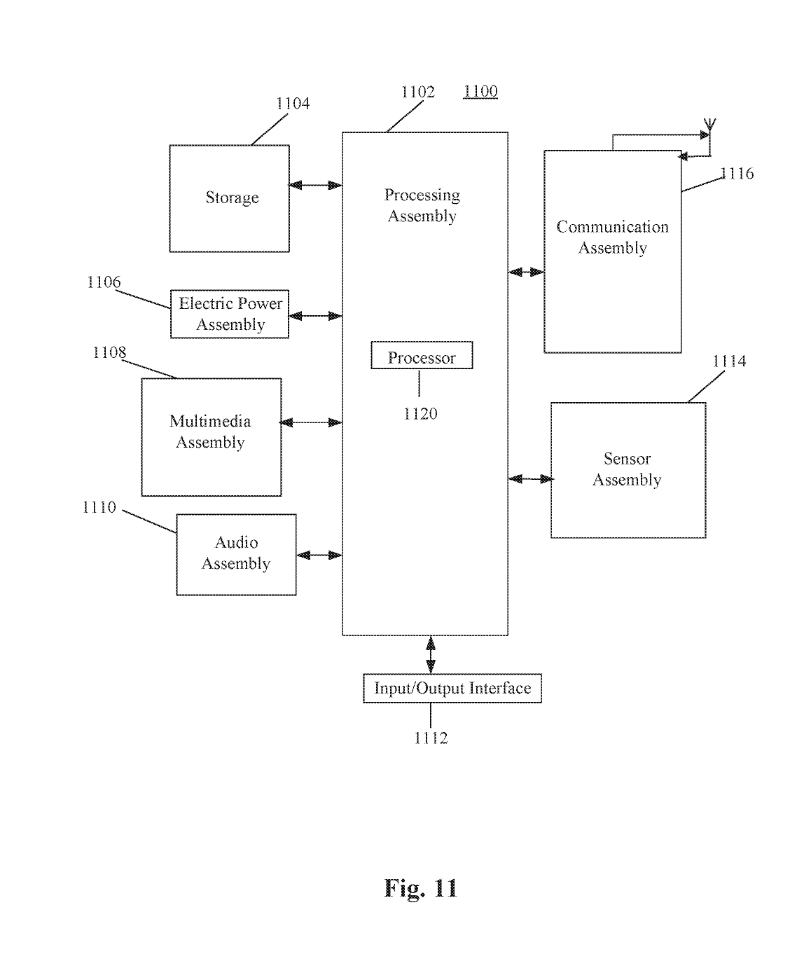

FIG. 11 is a block diagram of an apparatus for acquiring search results, according to an exemplary embodiment. For example, the apparatus is a terminal 1100, such as a mobile phone, computer, digital broadcast terminal, message sending and receiving equipment, game console, tablet device, medical equipment, fitness equipment, personal digital assistant and terminal and so on. The terminal 1100 may also be an intelligent router, intelligent air purifier, intelligent water purifier or intelligent camera and so on.

With reference to FIG. 11, the terminal 1100 may include one or more of the following components: a processing assembly 1102, a storage 1104, an electric power assembly 1106, a multimedia assembly 1108, an audio assembly 1110, an input/output (I/O) interface 1112, a sensor assembly 1114, and a communication assembly 1116.

The processing assembly 1102 generally controls the entire operations of the terminal 1100, such as operations related to display, telephone call, data communication, camera and recording. The processing assembly 1102 may include one or more processors 1120 to execute instructions, so as to accomplish all or a part of the steps of the above mentioned methods. In addition, the processing assembly 1102 may also include one or more modules to facilitate interaction between the processing assembly 1102 and other components. For example, the processing assembly 1102 may include a multimedia module to facilitate interaction between the multimedia assembly 1108 and the processing assembly 1102.

The storage 1104 is configured to store various types of data so as to support operations of the terminal 1100. Examples of these data include instructions used for any application program or method operated on the terminal 1100, contact person data, telephone book data, message, picture and video and so on. The storage 1104 may be implemented as any type of volatile or nonvolatile storage devices or their combinations, such as Static Random Access Memory (SRAM), Electrically Erasable Programmable Read Only Memory (EEPROM), Erasable Programmable Read Only Memory (EPROM), Programmable Read Only memory (PROM), Read Only Memory (ROM), magnetic memory, flash memory, magnetic disk or optical disc.

The electric power assembly 1106 supplies electric power to the various components of the terminal 1100. The electric power assembly 1106 may include a power source management system, one or more power sources and other components related to the generation, management and electric power distribution of the terminal 1100.

The multimedia assembly 1108 includes a screen that provides an output interface between the terminal 1100 and a user. In some embodiments, the screen may include a liquid crystal display (LCD) and a touch panel (TP). If the screen includes a touch panel, the screen can be implemented as a touch screen for receiving input signal from the user. The touch panel includes one or more touch sensors to sense touch, slide and gestures on the touch panel. The touch sensor may not only sense a boundary of the touch or slide actions, but also detect the time duration and pressure relevant to the touch or slide operations. In some embodiments, the multimedia assembly 1108 includes a front camera and/or a rear camera. When the terminal 1100 is in an operation mode, such as capture mode or video mode, the front camera and/or the rear camera may receive external multimedia data. Each of the front camera and the rear camera may be a fixed optical lens system or may have focal lengths and optical zooming functionality.

The audio assembly 1110 is configured to output and/or input audio signals. For example, the audio assembly 1110 includes a microphone (MIC), and, when the terminal 1100 is in an operation mode, such as call mode, recording mode and voice recognition mode, the microphone is configured to receive external audio signals. The received audio signals may be further stored in the storage 1104 or be transmitted via the communication assembly 1116. In some embodiments, the audio assembly 1110 further includes a loudspeaker for outputting audio signals.

The I/O interface 1112 provides an interface between the processing assembly 1102 and periphery interface modules, and the periphery interface modules may be keyboard, click wheel and buttons, etc. The buttons may include but not limited to: home button, volume button, start button and lock button.

The sensor assembly 1114 includes one or more sensors for providing the evaluation for every aspect of the terminal 1100. For example, the sensor assembly 1114 may detect on/off state of the terminal 1100 and detect the relative location of the components, for example, the components may be a display and a keypad of the terminal 1100; in addition, the sensor assembly 1114 may also detect position changes of the terminal 1100 or a component of the terminal 1100, whether the user contacting the terminal 1100 or not, the orientation or the acceleration/deceleration of the terminal 1100, and the temperature change of the terminal 1100. The sensor assembly 1114 may include a proximity sensor which is configured to be used for detecting existence of nearby objects when there is no physical contact. The sensor assembly 1114 may also include an optical sensor, such as CMOS or CCD image sensor, to be used in imaging applications. In some embodiments, the sensor assembly 1114 may further include an acceleration sensor, a gyroscope sensor, a magnetic sensor, a pressure sensor or a temperature sensor.

The communication assembly 1116 is configured to facilitate communication between the terminal 1100 and other devices. The terminal 1100 may access a wireless network on the basis of communication standards, such as WiFi, 2G or 3G, or their combinations. In an embodiment, the communication assembly 1116 receives broadcast signal or broadcast relevant information from external broadcast management systems via broadcast channels. In an embodiment, the communication assembly 1116 further includes a near field communication (NFC) module to promote short-range communications. For example, the NFC module may be implemented on the basis of Radio Frequency Identification (RFID) technology, Infrared Data Association (IrDA) technology, Ultra Wide Band (UWB) technology, Bluetooth (BT) technology and other technologies.

In the embodiments, the terminal 1100 may be implemented by one or more of Application Specific Integrated Circuit (ASIC), Digital Signal Processor (DSP), Digital Signal Processing Device (DSPD), Programmable Logic Device (PLD), Field Programmable Gate Array (FPGA), controller, microcontroller, microprocessor or other electronic elements, for performing the above mentioned methods.

There is provided a non-transitory computer readable storage medium including instructions, such as included in the storage 1104, executable by the processor 1120 of the terminal 1100, for performing the above described methods. For example, the non-temporary computer readable storage medium may be ROM, Random Access Memory (RAM), CD-ROM, magnetic tape, floppy disk and optical data storage devices and so on.

In this embodiment of the disclosure, when a terminal starts a search event, the terminal sends face information and the search query to a search server for login and search, and receives the user-related search results determined by the search server according to the face information and the search query, thereby the efficiency of login during the search process, the accuracy of the search results, and the human-machine interactivity is are improved.

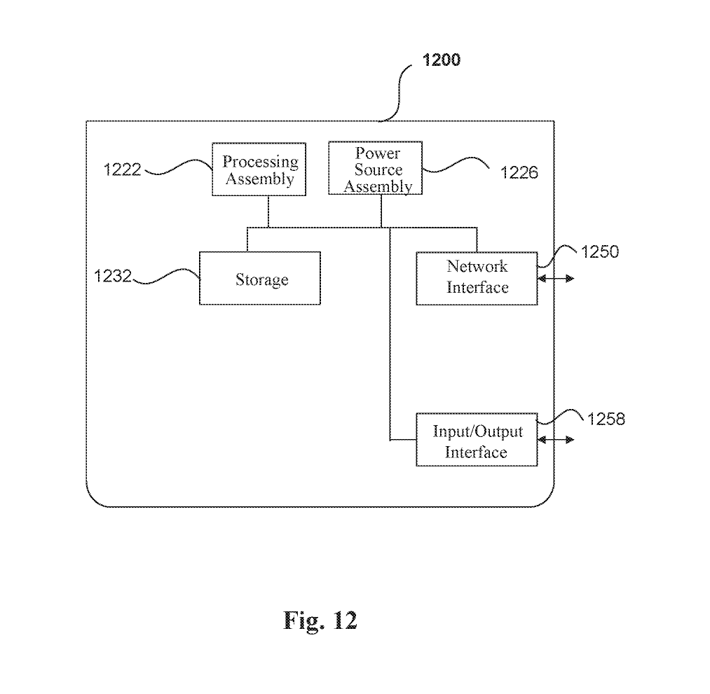

FIG. 12 is a block diagram showing an apparatus 1200 for acquiring search results according to an embodiment. For example, the apparatus 1200 may be any of the search servers described above. With reference to FIG. 12, the apparatus 1200 comprises a processing assembly 1222 which further comprises one or more processors, and storage resource represented by a storage 1232 for storing instructions executable by the processing assembly 1222, such as an application program. The application program stored in the storage 1232 may include one or more modules, each corresponding with a set of instructions. In addition, the processing assembly 1222 is configured to execute the instructions, so as to perform the above mentioned methods for acquiring search results.

The apparatus 1200 may also include a power source assembly 1226 configured to execute power management for the apparatus 1200, a wired or wireless network interface 1250 configured to connect the apparatus 1200 to a network, and an input/output (I/O) interface 1258. The apparatus 1200 may operate the operation system stored in the storage 1232, such as Windows Server™, Mac OS X™, Unix™, Linux™, Free BSD™ or the like.

There is provided a non-transitory computer readable storage medium including instructions, such as included in the storage 1232, executable by the processing assembly 1222 of the apparatus 1200, for performing the above described methods. For example, the non-temporary computer readable storage medium may be ROM, Random Access Memory (RAM), CD-ROM, magnetic tape, floppy disk and optical data storage devices and so on.

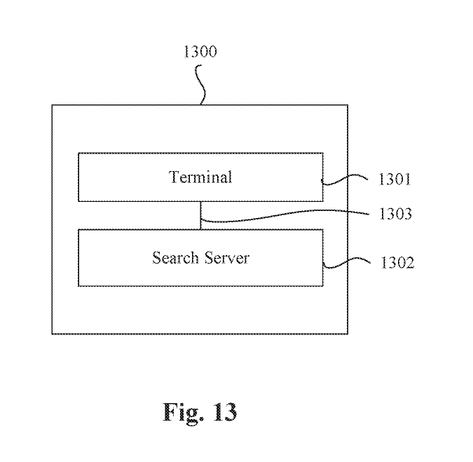

FIG. 13 is a block diagram showing a system 1300 for acquiring search results, consistent with embodiments of the present disclosure. The system 1300 includes a terminal 1301, a search server 1302, and a network 1303 coupled between the terminal 1301 and the search server 1302. The apparatus 600 (FIG. 6) may be used in the terminal 1301. The apparatus 900 (FIG. 9) may be used in the search server 1302. The methods 300, 400, and 500 may be executed by system 1300.

Other embodiments of this disclosure will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for acquiring search results, comprising:
acquiring face information of a user by face recognition, when detecting that a search event is started in a terminal;
sending a search request to a search server according to the face information and a search query of the search event; and
receiving user-related search results determined by the search server through a search based on the face information and the search query.

2. The method according to claim 1, wherein the acquiring face information of a user by face recognition comprises:
determining whether a time interval between a first time when the search event is started and a second time when a previous search event is started is greater than a predetermined time period; and
acquiring the face information of the user by face recognition if the time interval is greater than the predetermined time period.

3. The method according to claim 1, wherein the sending a search request to a search server comprises:
acquiring a searching-range identification, the searching-range identification including one or more of a device identification, a cloud service account, an application account, a location identification, or a network identification; and
sending the search request to the search server according to the searching-range identification, the face information, and the search query of the search event.

4. The method according to claim 1, further comprising:
after sending the search request to the search server according to the face information and the search query of the search event, receiving, from the search server, a search history record corresponding to the user; and
displaying the search history record corresponding to the user.

5. The method according to claim 4, further comprising:
after receiving the search history record corresponding to the user from the search server, hiding pre-stored search history records not related to the user.

6. The method according to claim 1, further comprising:
detecting that the user has not logged in the search server;
sending a login request to the search server according to the face information; and
receiving a login response from the search server after the search server performs verification of the user according to the face information.

7. A method for acquiring search results, comprising:
receiving a search request sent by a terminal, the search request including at least face information of a user and a search query;
verifying whether the face information belongs to a registered user;
if the face information belongs to a registered user, performing a search based on the search query according to a personalized search pattern of the registered user, and determining search results related to the registered user; and
sending the search results related to the registered user to the terminal.

8. The method according to claim 7, wherein the search request includes a searching-range identification, the searching-range identification including one or more of a device identification, a cloud service account, an application account, a location identification, or a network identification; and the verifying whether the face information belongs to a registered user comprises:
acquiring the registered user associated with the searching-range identification;
verifying whether the face information belongs to the registered user associated with the searching-range identification; and
determining that the face information belongs to a registered user, if the face information belongs to the registered user associated with the searching-range identification.

9. The method according to claim 8, further comprising:
if the face information does not belong to the registered user associated with the searching-range identification, creating a user account according to the face information and the searching-range identification.

10. The method according to claim 7, further comprising:
if the face information belongs to a registered user, sending a search history record corresponding to the registered user to the terminal.

11. A terminal for acquiring search results, comprising:
a processor; and
a storage device for storing instructions executable by the processor,
wherein the processor is configured to:
acquire face information of a user by face recognition, when detecting that a search event is started in the terminal;
send a search request to a search server according to the face information and a search query of the search event; and
receive user-related search results determined by the search server through a search based on the face information and the search query.

12. The terminal according to claim 11, wherein the processor is further configured to:
determine whether a time interval between a first time when the search event is started and a second time when a previous search event is started is greater than a predetermined time period; and
acquire the face information of the user by face recognition if the time interval is greater than the predetermined time period.

13. The terminal according to claim 11, wherein the processor is further configured to:
acquire a searching-range identification, the searching-range identification including one or more of a device identification, a cloud service account, an application account, a location identification, or a network identification; and
send the search request to the search server according to the searching-range identification, the face information, and the search query of the search event.

14. The terminal according to claim 11, wherein the processor is further configured to:
receive a search history record corresponding to the user from the search server; and
display the search history record corresponding to the user.

15. The terminal according to claim 14, wherein the processor is further configured to:
hide pre-stored search history records not related to the user.

16. The terminal according to claim 11, wherein the processor is further configured to:
detect that the user has not logged in the search server;
send a login request to the search server according to the face information; and
receive a login response from the search server after the search server performs verification of the user according to the face information.

17. A server for acquiring search results, comprising:
a processor; and
a storage device for storing instructions executable by the processor,
wherein the processor is configured to:
receive a search request sent by a terminal, the search request including at least face information of a user and a search query;
verify whether the face information belongs to a registered user;
if the face information belongs to a registered user, perform a search based on the search query according to a personalized search pattern of the registered user, and determine search results related to the registered user; and
send the search results related to the registered user to the terminal.

18. The server according to claim 17, wherein the processor is further configured to:
acquire the registered user associated with the searching-range identification;
verify whether the face information belongs to the registered user associated with the searching-range identification; and
determine that the face information belongs to a registered user, if the face information belongs to the registered user associated with the searching-range identification.

19. The server according to claim 18, wherein the processor is further configured to:
if the face information does not belong to the registered user associated with the searching-range identification, create a user account according to the face information and the searching-range identification.

20. The server according to claim 17, wherein the processor is further configured to:
if the face information belongs to a registered user, send a search history record corresponding to the registered user to the terminal.
